(19) United States
(12) Patent Application Publication
(10) Pub. No.: US 2014/0029456 A1
(43) Pub. Date: Jan. 30, 2014

(54) INTERFERENCE ESTIMATION IN THE PRESENCE OF ePDCCH TRANSMISSIONS

(71) Applicant: QUALCOMM Incorporated, San Diego, CA (US)

(72) Inventors: Siddhartha MALLIK, San Diego, CA (US); Tao LUO, San Diego, CA (US); Taesang YOO, San Diego, CA (US)

(21) Appl. No.: 13/943,718

(22) Filed: Jul. 16, 2013

Related U.S. Application Data
(60) Provisional application No. 61/676,797, filed on Jul. 27, 2012.

(51) Int. Cl. H04J 11/00

(52) U.S. Cl. CPC H04J 11/0023
USPC 370/252

(57) ABSTRACT

A method of wireless communication is presented. The method includes determining, for each resource element group of a resource block pair, whether an interfering control channel is present on the resource block pair. The determination may be based on whether estimated power of the resource element groups varies among two or more resource element groups. The method also includes estimating the interference on the resource block pair based on the determination.

### CROSS-REFERENCE TO RELATED APPLICATION

This application claims the benefit under 35 U.S.C. §119(e) to U.S. Provisional Patent Application No. 61/676,797 entitled “INTERFERENCE ESTIMATION IN THE PRESENCE OF EPDCCH TRANSMISSIONS,” filed on Jul. 27, 2012, the disclosure of which is expressly incorporated by reference herein in its entirety.

### BACKGROUND

1. Field

Aspects of the present disclosure relate generally to wireless communication systems, and more particularly to estimating interference for a resource block pair based on the presence of an enhanced control channel.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

Resource blocks carrying a data transmission from a serving eNodeB may see interference from a control transmission of an interfering eNodeB. However, not all control channel elements may be used by the interferer for its control payload, and different tones within a resource block (RB) pair may see different interference levels. Using a single interference estimate for the entire resource block pair may not provide accurate estimates. One aspect of the present disclosure is directed to improving the accuracy of interference estimates in the presence of an interferer cell by adjusting the interference estimate for different portions of a resource block pair based on whether the resource block pair includes an enhanced control channel.

In one aspect of the present disclosure, a method of wireless communication is disclosed. The method includes determining, for a plurality of resource element groups in a resource block pair, whether an interfering control channel is present on the resource block pair. The determining may be based on whether estimated power of resource element groups varies among the plurality of resource element groups. The method also includes estimating interference on the resource block pair based on the determination.

Another aspect of the present disclosure discloses an apparatus including means for determining, for a plurality of resource element groups in a resource block pair, whether an interfering control channel is present on the resource block pair. The means for determining may be based on whether estimated power of resource element groups varies among the plurality of resource element groups. The apparatus also includes means for estimating interference on the resource block pair based on the determination.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining, for a plurality of resource element groups in a resource block pair, whether an interfering control channel is present on the resource block pair. The program code may determine based on whether estimated power of resource element groups varies among the plurality of resource element groups. The program code also includes program code to estimate interference on the resource block pair based on the determination.

Another aspect discloses wireless communication having a memory and at least one processor coupled to the memory. The processor(s) is configured to determine, for a plurality of resource element groups in a resource block pair, whether an interfering control channel is present on the resource block pair. The at least one processor may be configured to determine based on whether estimated power of resource element groups varies among the plurality of resource element groups. The at least one processor is further configured to estimate interference on the resource block pair based on the determination.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIGS. 7-10 are block diagrams illustrating methods for estimating interference in the presence of an interfering eNodeB according to aspects of the present disclosure.

FIG. 11 is a conceptual data flow diagram illustrating the data flow between different modules/means/components in an exemplary apparatus.

FIG. 12 is a block diagram illustrating different modules/means/components in an exemplary apparatus.

FIG. 13 is a block diagram illustrating a method for estimating interference in the presence of an interfering eNodeB according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a non-transitory computer-readable medium. Computer-readable media includes computer storage media. Storage media may be any available media that can be accessed by a computer. Combinations of the above should also be included within the scope of computer-readable media.

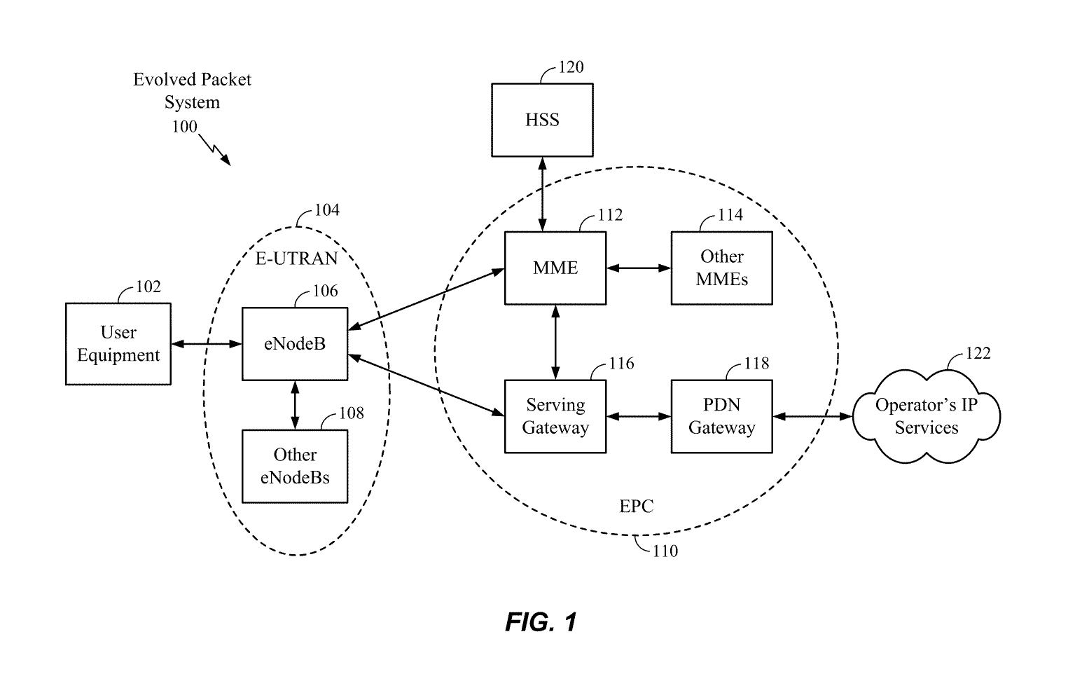

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

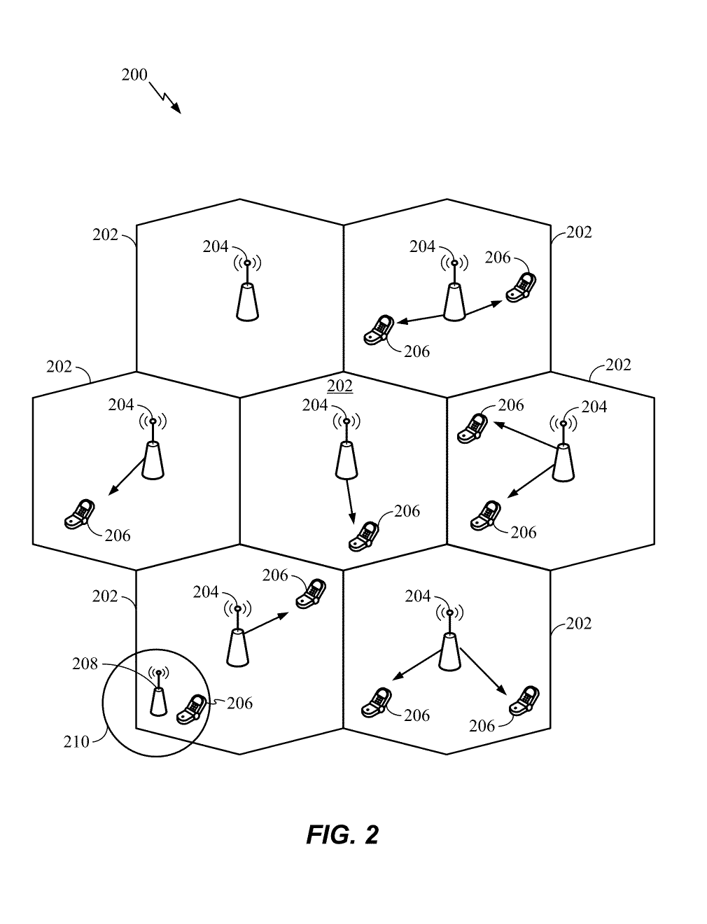

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

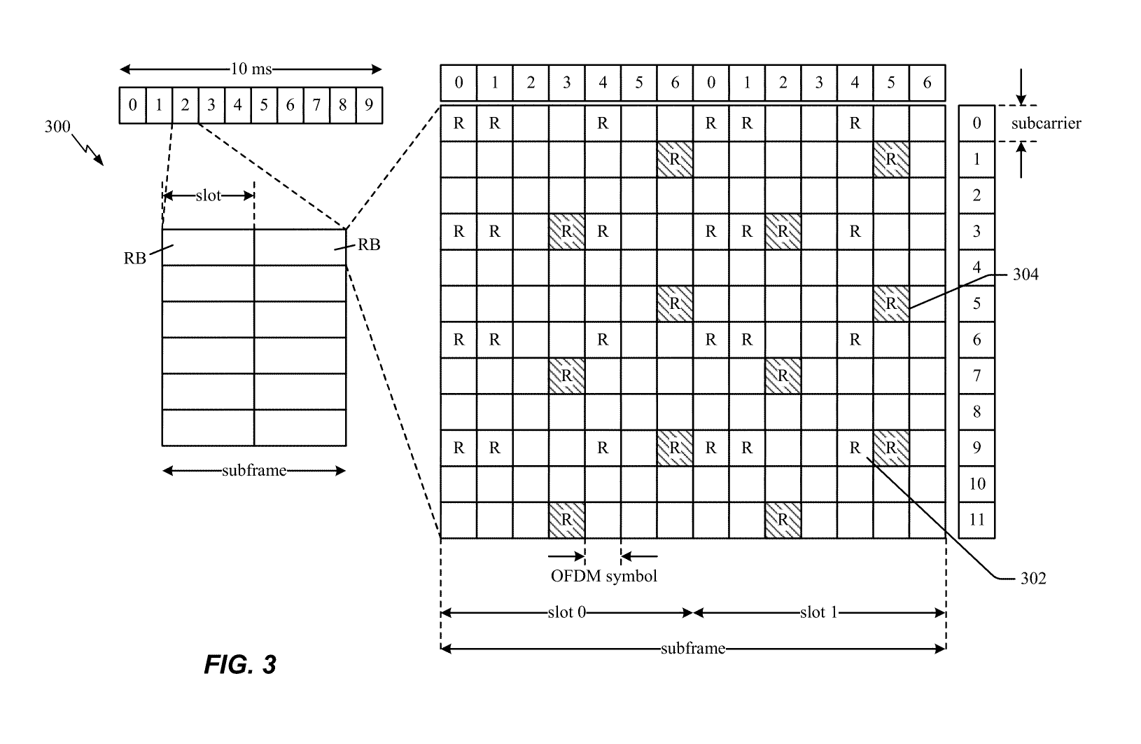

FIG. 3 is a diagram 300 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

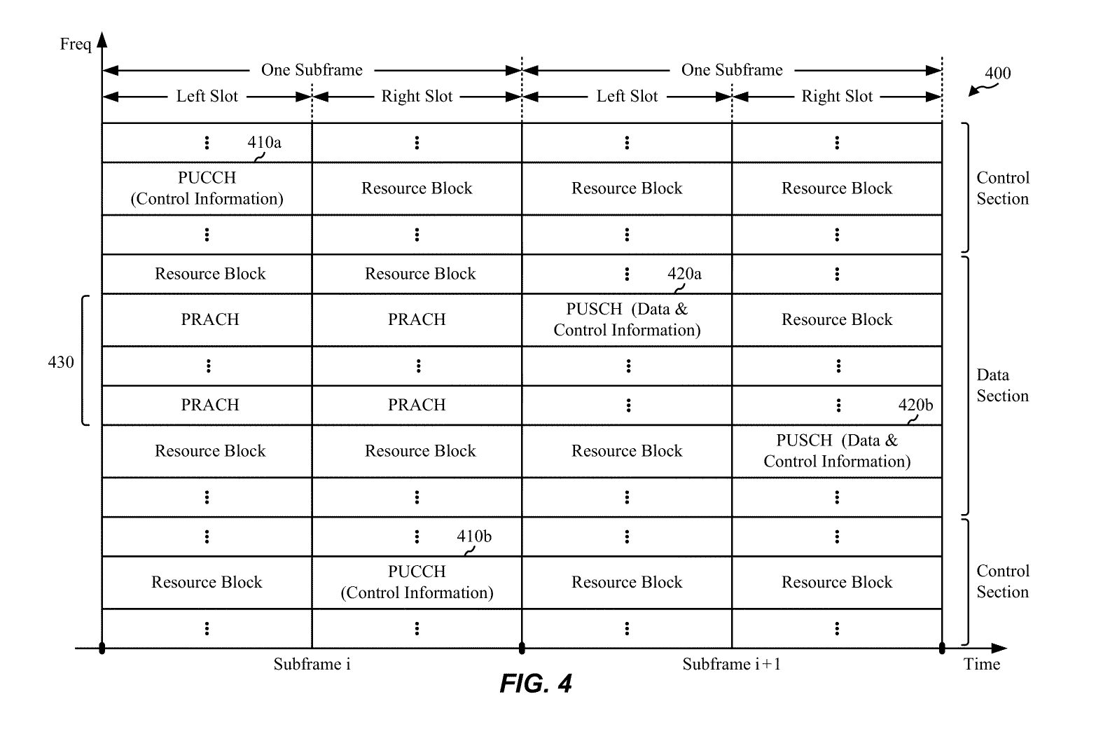

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

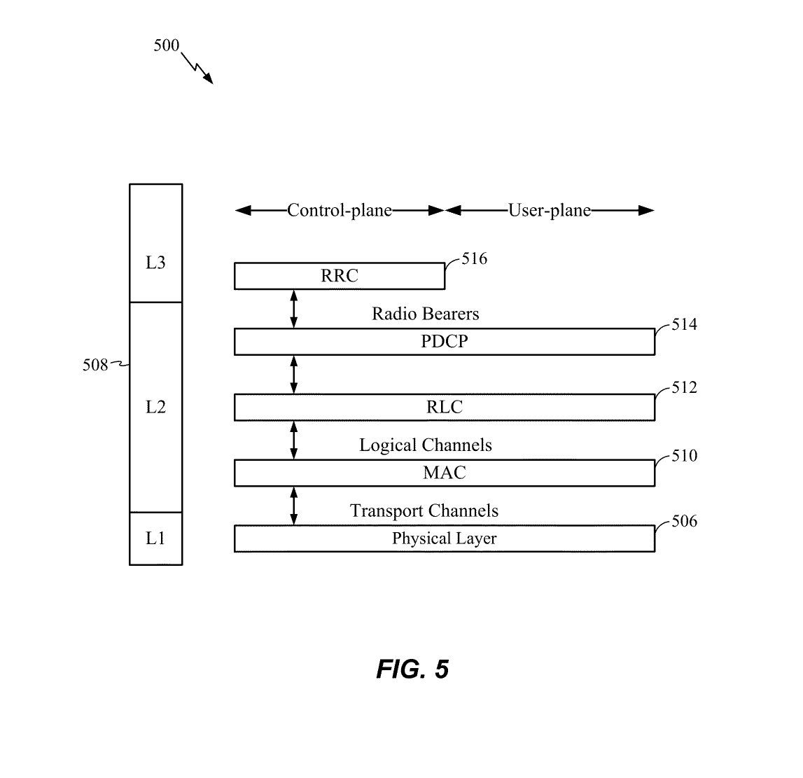

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

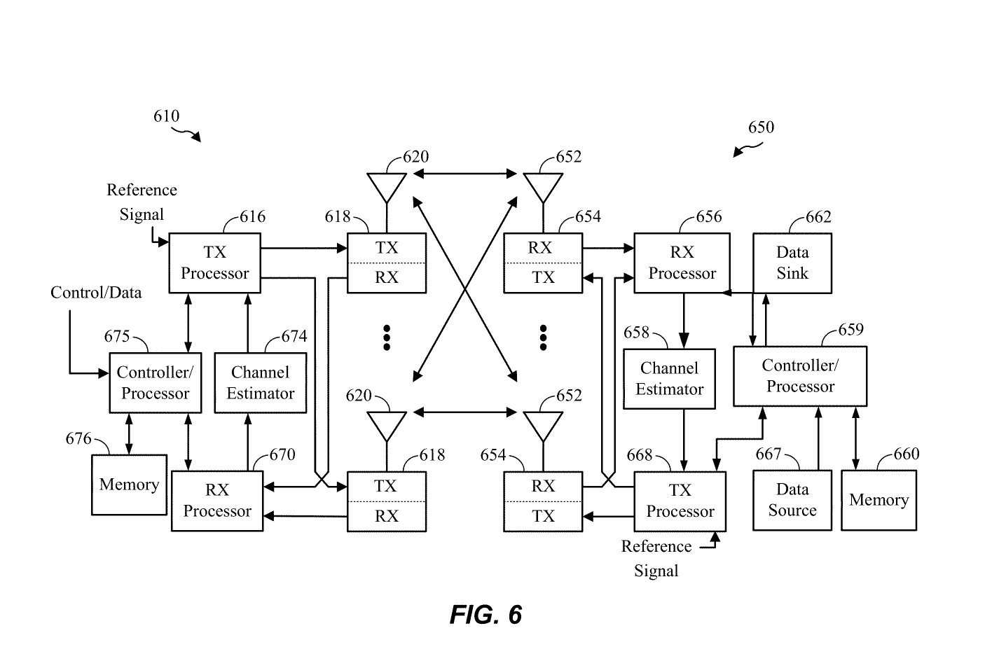

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Improving Interference Estimation in the Presence of an EPDCCH Interferer

In LTE Release 11 and subsequent LTE releases, a data transmission from a serving eNodeB may experience interference from enhanced control channel transmissions of a neighboring eNodeB (i.e., interfering eNodeB). In some cases, an interfering eNodeB may not use all control channel elements (CCEs) in a control payload. That is, the interfering eNodeB may be partially loaded. As a result of the partial loading, different symbols within a resource block (RB) pair of the serving eNodeB may experience different interference from the enhanced control channel transmissions of the neighboring eNodeB. Typically, the serving eNodeB may use a single interference estimate for the resource block pair. The interference estimate may be obtained from either common reference signals (CRS) and/or UE reference signals (UE-RS). Still, the interference estimate obtained from the common reference signals and/or the UE reference signals (UE-RSs) may assume a full loading. Thus, when the interfering cell is partially loaded, the interference may not be consistent across the resource block pair. Therefore, the interference estimate may be inaccurate due to the assumed full loading.

One aspect of the present disclosure is directed to improving interference estimates in the presence of an interfering eNodeB that may use an enhanced control channel, such as the enhanced physical downlink control channel (EPDCCH).

The enhanced control channel is transmitted using a resource block pair. A typical resource block is a set of twelve contiguous symbols in a slot. A resource block pair refers to two resource blocks, one in each slot of a given subframe. In some cases, UE reference signals (UE-RS) may be used for enhanced control channel demodulation and decoding. The basic granularity of an enhanced control channel resource is a resource element group (REG). Still, not all resource element groups in a resource block pair may be used for transmitting enhanced control channels. The resource block pairs used for enhanced control channel are typically conveyed from a serving eNodeB to its served UE via radio resource control (RRC) signaling. Typically, a UE does not receive signaling that identifies the resource element groups (REGs) on which an interfering eNodeB transmits an enhanced control channel.

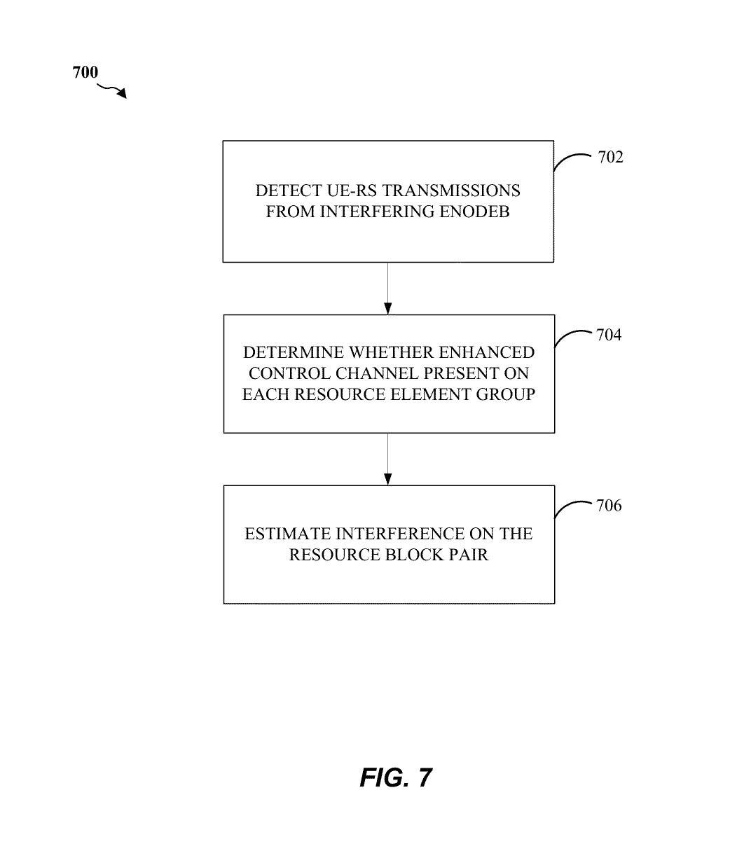

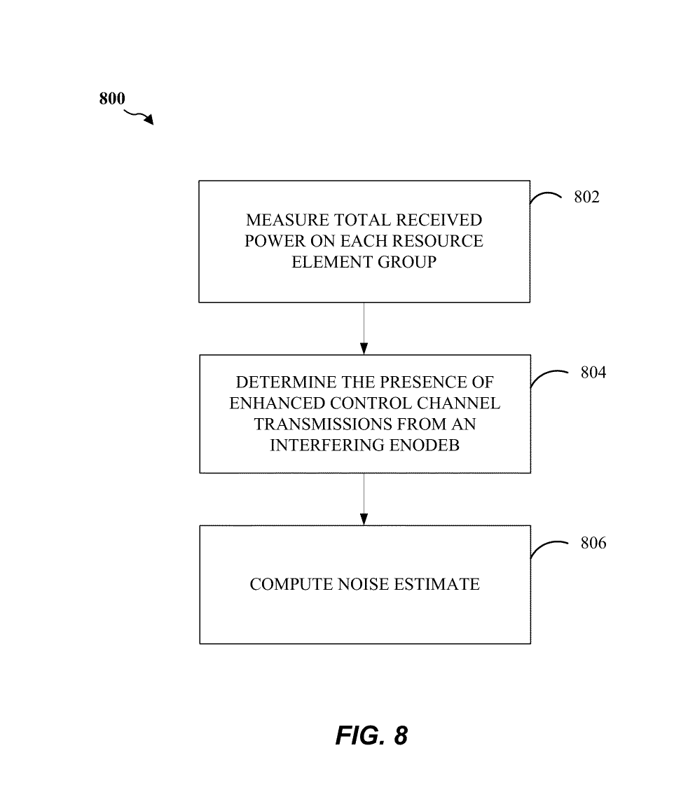

FIG. 7 illustrates a method 700 for estimating the interference by determining the presence of an enhanced control channel in a resource block pair based on an aspect of the disclosure. In one configuration, at block 702 of FIG. 7, a UE detects UE-RS transmissions from an interfering eNodeB. At block 704, in response to detecting the UE-RS transmissions, the UE determines the presence of an enhanced control channel from the interfering eNodeB. In some cases, the observed interference from the enhanced control channel is bursty. Additionally, in some cases, the enhanced control channel may be transmitted using a granularity that is smaller than the granularity used for a shared downlink channel.

In one configuration, the presence of the enhanced control channel (block 704) may be detected by determining variations in received power between resource element groups (REGs). In block 706, the UE estimates interference on a resource block pair after determining the presence of the enhanced control channel. This proceeds by as follows: the UE-RS power of the interfering eNodeB is estimated based on the interfering eNodeB's UE-RS transmissions.

Additionally, after determining the presence of a UE-RS transmission by an interfering eNodeB in a resource block pair, the UE may determine the absence or presence of the enhanced control channel in resource element groups based on an estimate of the traffic to pilot ratio (TPR) of the transmissions of the interfering eNodeB Furthermore, a raw interference matrix may be developed based on the interference determined from the UE-RS tones of the serving eNodeB. Moreover, the raw interference matrix may be updated based on the UE-RS power and the resource element group traffic to pilot ratio estimate of the interfering eNodeB.

As previously discussed, a UE detects the presence of UE-RS transmissions from an interfering eNodeB in a resource block pair. The presence of a UE-RS may indicate the presence of an enhanced control channel. However, the presence of the UE-RS is not a requisite condition for the presence of an enhanced control channel, as the UE-RS may also be used to transmit a transmission mode 9 (TM9) shared downlink channel. In one configuration, the UE estimates the power at which the interfering cell transmits the UE-RS (P_{UE-RS}_{_{—}}_{interfering}). Additionally, the UE may also estimate the power at which the serving cell transmits the UE-RS (P_{UE-RS}_{_{—}}_{serving}).

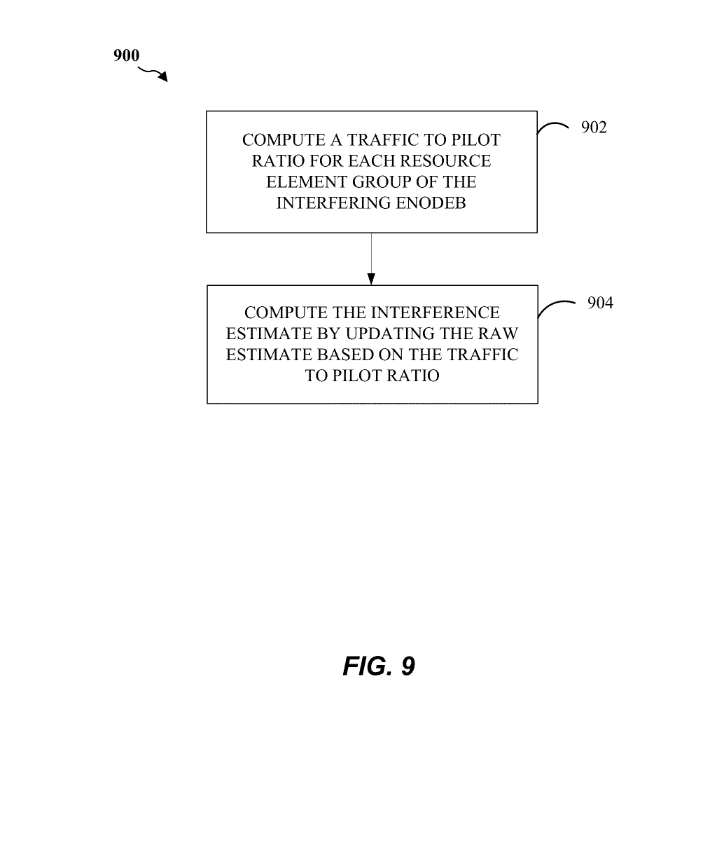

FIG. 9 illustrates a method 800 for determining whether an enhanced control channel is present in the transmission from the interferer.

In block 802, the UE measures a total received power of each resource element group k (Pₜₒₜₐₗ_{_{—}}_{reg}[k]). The UE may measure the total received power to determine if there are variations in the total power of each resource element group. The variations may be determined for all resource element groups in a resource block pair or a subset of resource element groups in a resource block pair.

In block 804, the UE determines the presence of enhanced control channel transmissions from an interfering eNodeB based on detected variations in the total received power for each resource element group. The UE determines a variation when one or more resource element groups have a total power that is greater than the total power of other resource element groups. A variation in the received power suggests the interfering cell is using a resource block pair for an enhanced control channel (e.g., EPDCCH). More specifically, the presence of an enhanced control channel from an interfering cell is indicated when the Pₜₒₜₐₗ_{_{—}}_{reg}[k] shows variation on the order of the power measurement of the UE-RS of the interfering eNodeB (P_{UE-RS}_{_{—}}_{interfering}).

Furthermore, in block 806, a noise estimate (NT_{serving}_{_{—}}_{raw}) is computed using the serving cell UE-RS. The noise estimate may be referred to as a raw estimate. The raw estimate (i.e., NT_{serving}_{_{—}}_{raw}) may be a reference value used to compute an improved interference estimate at each resource element group. The improved interference estimate may depend on whether a specific resource element group includes an enhanced control channel transmission. The noise estimate, which is one estimate for the entire resource block pair, may be updated as described below.

FIG. 9 illustrates a method 900 for estimating interference by determining the presence of an enhanced control channel (e.g., EPDCCH) in a resource block pair, in one aspect of the disclosure.

In block 902, a traffic to pilot ratio of the interfering eNodeB is computed for each resource element group to determine whether each resource element group includes an enhanced control channel. γ[k] is a parameter that indicates the absence or presence of the enhanced control channel for each resource element group k. The value of γ[k] is between 0 and −1. In one configuration, because the raw estimate includes a contribution from the interfering cell, a presence of an enhanced control channel on a resource element group is indicated when γ[k] is equal to 0. Alternatively, an absence of the enhanced control channel on resource element group is indicated when γ[k] is equal to −1. γ[k] is defined as:

γ[k]=(Pₜₒₜₐₗ_{_{—}}_{reg}[k]−P_{UE-RS}_{_{—}}_{serving}−NT_{serving}_{_{—}}_{raw})/P_{UE-RS}_{_{—}}_{interfering} (1)

In equation (1), Pₜₒₜₐₗ_{_{—}}_{reg}[k] is the total power received on resource element group [k] (REG[k]), P_{UE-RS}_{_{—}}_{serving} is the power of the UE reference signal of the serving eNodeB, NT_{serving}_{_{—}}_{raw} is the noise estimate using the serving eNodeB UE reference signal, and P_{UE-RS}_{_{—}}_{interfering} is the power of the UE reference signal of the interfering eNodeB.

After γ[k] is computed, in block 904, the raw estimate (NT_{serving}_{_{—}}_{raw}) is updated on an resource element group to resource element group basis to compute an updated interference estimate (NT_{serving}). The updated interference estimate (NT_{serving}) is defined as:

NT_{serving}=NT_{serving}_{_{—}}_{raw}+γ[k]*P_{UE-RS}_{_{—}}_{interfering} (2)

In the aforementioned aspects of the present disclosure, the interference was estimated for each resource element group. In the presence of a single dominant interferer, these computations may also be performed for each control channel element (CCE) or each enhanced control channel element (ECCE).

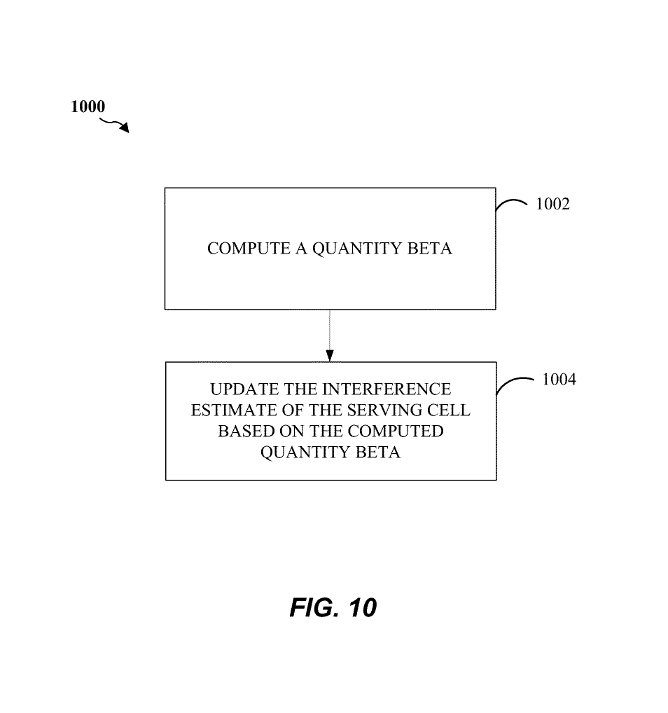

In another aspect of the present disclosure, in addition to determining the raw estimate (NTserving_raw), an estimate of the interference experienced by the UE-RS symbols of the interfering eNodeB (NT_{interfering}_{_{—}}_{raw}) may also be determined. FIG. 10 illustrates a method 1000 for computing the interference experienced on the UE-RS of the interfering eNodeB.

In block 1002, a quantity, β[k] corresponding to the traffic to pilot ratio (TPR) of the interfering eNodeB. Specifically, β[k] is a measurement of the presence or absence of enhanced control channel of an interferer on a specific resource element group. A β value of 0 indicates absence, and a value of 1 indicates presence. β is computed as follows:

β[k]=(Pₜₒₜₐₗ_{_{—}}_{reg}[k]−NT_{interfering}_{_{—}}_{raw})/P_{UE-RS}_{_{—}}_{interfering} (3)

In equation 3, Pₜₒₜₐₗ_{_{—}}_{reg}[k] is the total power of the resource element groups and P_{UE-RS}_{_{—}}_{interfering} is the power measurement of the UE-RS of the interfering eNodeB. Furthermore, in block 1004, the updated interference estimate NT_{serving} is determined by either equations (4) or (5):

NT_{serving}=NT_{serving}_{_{—}}_{raw}−(1−β[k])*P_{UE-RS}_{_{—}}_{interfering} (4)

NT_{serving}=NT_{interfering}_{_{—}}_{raw}−P_{UE-RS}_{_{—}}_{serving}+β[k]*P_{UE-RS}_{_{—}}_{interfering} (5)

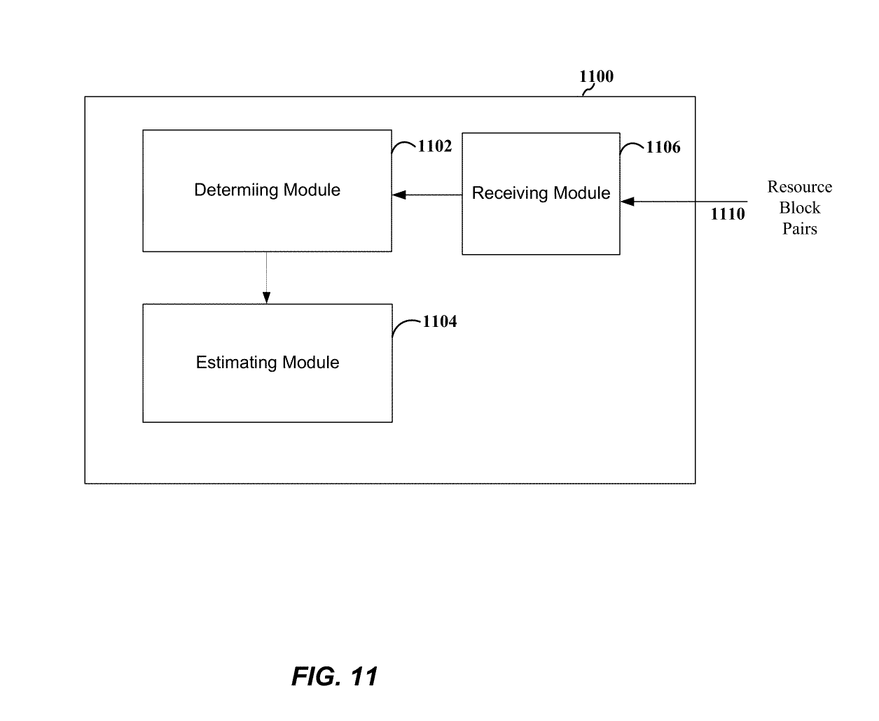

FIG. 11 is a conceptual data flow diagram illustrating the data flow between different modules/means/components in an exemplary apparatus 1100. The apparatus 1100 includes a determining module 1102 that determines, for each resource element group of a resource block pair, whether an interfering control channel is present on the resource block pair. The determining may be based on whether an estimated power of resource element groups varies among two or more resource element groups. The apparatus 1100 also includes a estimating module 1104 that estimates interference on the resource block pair based on the determination. The determining module transmits the results of the determination to the estimating module. The apparatus 1100 may further include a receiving module 1106 that receives resource block pairs from a signal 1110 transmitted by an interfering eNodeB. The receiving module may transmit the received resource block pairs to the determining module 1102.

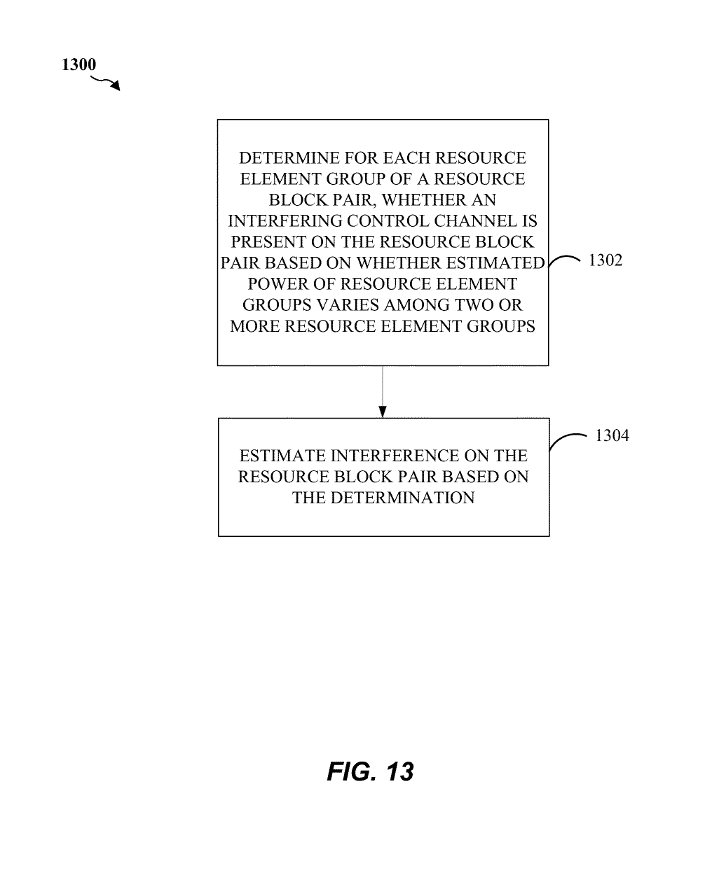

The apparatus may include additional modules that perform each of the steps of the process in the below mentioned flow chart of FIG. 13. As such, each step in the below mentioned flow chart FIG. 13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

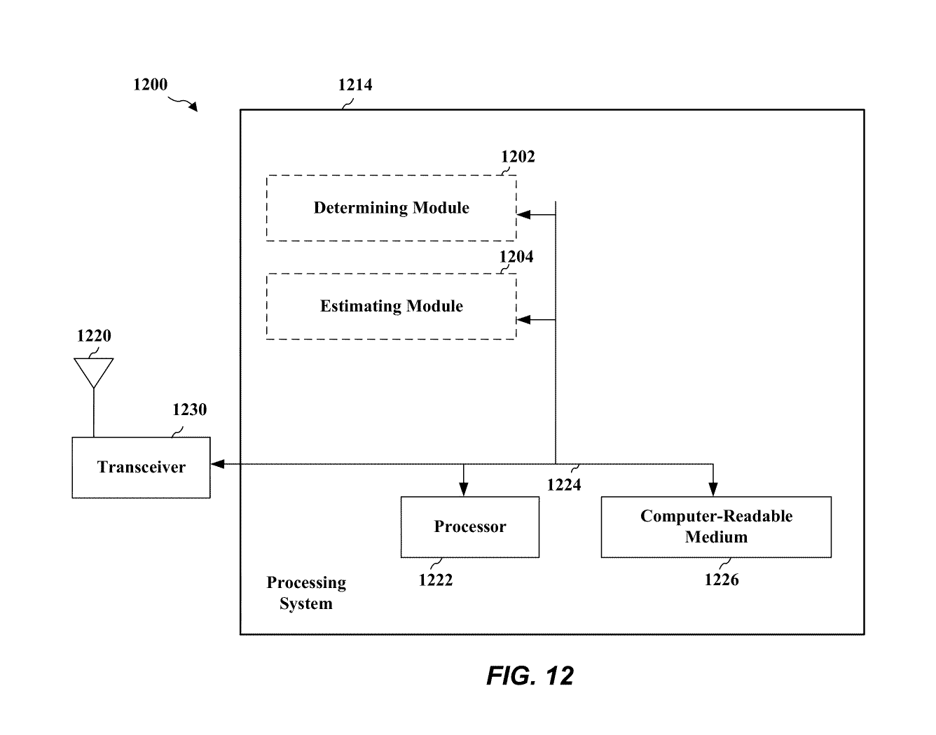

FIG. 12 is a diagram illustrating an example of a hardware implementation for an apparatus 1200 employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222 the modules 1202, 1204 and the computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a determining module 1202 for determining, for each resource element group of a resource block pair, whether an interfering control channel is present on the resource block pair based on whether an estimated power of resource element groups varies among two or more resource element groups. The processing system 1214 also includes a estimating module 1204 for estimating interference on the resource block pair based on the determination. The modules may be software modules running in the processor 1222, resident/stored in the computer-readable medium 1226, one or more hardware modules coupled to the processor 1222, or some combination thereof. The processing system 1214 may be a component of the UE 650 and may include the memory 660, and/or the controller/processor 659.

FIG. 13 illustrates a method 1300 for estimating interference in the presence of an enhanced control channel. In block 1302, a UE determines, for each resource element group of a resource block pair, whether an interfering control channel is present on the resource block pair based on whether an estimated power of resource element groups varies among two or more resource element groups. That is, the estimated power of a resource element group is compared to the estimated power of other resource element groups to determine whether the estimated power varies across the resource element groups of the resource block pair. In one configuration, the determining may be further based on a user equipment reference signal transmission power of an interfering eNodeB. In this configuration, the determining may also be based on a user equipment reference signal transmission power of an serving eNodeB.

The UE estimates interference on the resource block pair based on the determination in block 1304. In the present aspect, the interference estimate mitigates inaccurate interference estimates of partially loaded resource block pairs. To improve the interference estimates, in one configuration, the interference estimate may be performed for each resource element group.

In another configuration, the interference estimate is also based on a user equipment reference signal transmission power of an interfering signal and a traffic to pilot ratio estimate of the interfering signal for each resource element group.

In yet another configuration, the interface estimate is further based on a user equipment reference signal transmission power of an interfering signal, a total power of a received signal for each resource element group, interference seen on the user equipment reference signal of the interfering signal and interference seen on the user equipment reference signal of a signal from a serving eNodeB.

In still yet another configuration, the interference estimate is further based on a user equipment reference signal transmission power of an interfering signal, a total power of a received signal for each resource element group, a user equipment reference signal transmission power of a signal from a serving eNodeB and interference seen on the user equipment reference signal of the interfering signal.

In one configuration, the UE 650 is configured for wireless communication including means for determining and means for estimating. In one configuration, the estimating means and/or the determining means may be the controller/processor 659, memory 660, receive processor 656, antenna 652, and/or demodulators 654 configured to perform the functions recited by the estimating means and/or the determining means. In another aspect, the aforementioned means may be any module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, for a plurality of resource element groups (REGs) in a resource block (RB) pair, whether an interfering control channel is present on the RB pair based at least, in part, on whether an estimated power of REGs varies among the plurality of REGs; and
estimating interference on the RB pair based on the determination.

2. The method of claim 1, in which the determining is based at least in part on a user equipment reference signal (UE-RS) transmission power of an interfering signal.

3. The method of claim 2, in which the determining is further based at least in part on a UE-RS transmission power of a signal from a serving eNodeB.

4. The method of claim 1, further comprising determining an interference estimate based on interference on a user equipment reference signal (UE-RS).

5. The method of claim 4, further comprising updating the interference estimate based at least in part on a UE-RS transmission power of an interfering signal and a traffic to pilot ratio estimate of the interfering signal for each REG.

6. The method of claim 4, further comprising updating the interference estimate based at least, in part, on one or more of:
a UE-RS transmission power of an interfering signal,
a total power of a received signal for each REG,
interference detected on the UE-RS of the interfering signal,
interference detected on the UE-RS of a signal from a serving eNodeB, or a combination thereof.

7. The method of claim 4, further comprising updating the interference estimate based at least in part on one or more of:
a UE-RS transmission power of an interfering signal,
a total power of a received signal for each REG,
a UE-RS transmission power of a signal from a serving eNodeB,
interference detected on the UE-RS of the interfering signal, or a combination thereof.

8. The method of claim 4, in which the interference estimate is determined independently for each REG.

9. The method of claim 1, in which the interfering control channel is an enhanced physical downlink control channel (EPDCCH).

10. The method of claim 1, in which the RB pairs are within a data region.

11. The method of claim 1, in which the plurality of REGs include all REGs in the RB pair.

12. The method of claim 1, in which the plurality of REGs include a subset of all REGs in the RB pair.

13. An apparatus for wireless communications, comprising:
a memory; and
at least one processor coupled to the memory, the at least one processor being configured:
to determine, for a plurality of resource element groups (REGs) in a resource block (RB) pair, whether an interfering control channel is present on the RB pair based at least, in part, on whether an estimated power of REGs varies among the plurality of REGs; and
to estimate interference on the RB pair based on the determination.

14. The apparatus of claim 13, in which the at least one processor is further configured to determine based at least in part on a user equipment reference signal (UE-RS) transmission power of an interfering signal.

15. The apparatus of claim 14, in which the at least one processor is further configured to determine based at least in part on a UE-RS transmission power of a signal from a serving eNodeB.

16. The apparatus of claim 13, in which the at least one processor is further configured to determine an interference estimate based on interference on a user equipment reference signal (UE-RS).

17. The apparatus of claim 16, in which the at least one processor is further configured to update the interference estimate based at least in part on a UE-RS transmission power of an interfering signal and a traffic to pilot ratio estimate of the interfering signal for each REG.

18. The apparatus of claim 16, in which the at least one processor is further configured to update the interference estimate based at least, in part, on one or more of:
a UE-RS transmission power of an interfering signal,
a total power of a received signal for each REG,
interference detected on the UE-RS of the interfering signal,
interference detected on the UE-RS of a signal from a serving eNodeB, or a combination thereof.

19. The apparatus of claim 16, in which the at least one processor is further configured to update the interference estimate based at least in part on one or more of:
a UE-RS transmission power of an interfering signal,
a total power of a received signal for each REG,
a UE-RS transmission power of a signal from a serving eNodeB,
interference detected on the UE-RS of the interfering signal, or a combination thereof.

20. The apparatus of claim 16, in which the interference estimate is determined independently for each REG.

21. The apparatus of claim 13, in which the interfering control channel is an enhanced physical downlink control channel (EPDCCH).

22. The apparatus of claim 13, in which the RB pairs are within a data region.

23. The apparatus of claim 13, in which the plurality of REGs include all REGs in the RB pair.

24. The apparatus of claim 13, in which the plurality of REGs include a subset of all REGs in the RB pair.

25. An apparatus for wireless communications, comprising:
means for determining, for a plurality of resource element groups (REGs) in a resource block (RB) pair, whether an interfering control channel is present on the RB pair based at least, in part, on whether an estimated power of REGs varies among the plurality of REGs; and
means for estimating interference on the RB pair based on the determination.

26. A computer program product for wireless communications, the computer program product comprising:
a non-transitory computer-readable medium having program code recorded thereon, the program code comprising:
program code to determine, for a plurality of resource element groups (REGs) in a resource block (RB) pair, whether an interfering control channel is present on the RB pair based at least, in part, on whether an estimated power of REGs varies among the plurality of REGs; and
program code to estimate interference on the RB pair based on the determination.
